(19) United States
(12) Patent Application Publication
(10) Pub. No.: US 2021/0229667 A1
(43) Pub. Date: Jul. 29, 2021

(54) VEHICLE CONTROL APPARATUS AND VEHICLE CONTROL METHOD

(71) Applicant: HONDA MOTOR CO., LTD., Tokyo (JP)

(72) Inventors: Kouhei MIYAMOTO, Tokyo (JP); Jun OCHIDA, Wako-shi (JP); Shigenori TAKIMOTO, Tokyo (JP)

(21) Appl. No.: 17/143,320

(22) Filed: Jan. 7, 2021

(30) Foreign Application Priority Data
Jan. 29, 2020 (JP) 2020-012824

(51) Int. Cl. B60W 30/18; B60W 50/04; B62D 15/02; B60W 60/00

(52) U.S. Cl. CPC B60W 30/18127; B60W 50/045; B60W 2050/0018; B60W 60/001; B62D 15/021

(57) ABSTRACT

The present invention provides a vehicle control apparatus that controls automated driving of a vehicle, comprising: a first controller configured to perform travel control of the vehicle by controlling a first actuator; and a second controller configured to perform travel control of the vehicle by controlling a second actuator which is different from the first actuator, as alternative control to be performed in a case in which degradation of a control function is detected in the first controller, wherein in a case of starting the alternative control, the travel control of the vehicle by the first controller is gradually shifted to the travel control of the vehicle by the second controller.

### CROSS-REFERENCE TO RELATED APPLICATION(S)

This application claims priority to and the benefit of Japanese Patent Application No. 2020-012824 filed on Jan. 29, 2020, the entire disclosure of which is incorporated herein by reference.

### BACKGROUND OF THE INVENTION

### Field of the Invention

The present invention relates to a vehicle control technique.

### Description of the Related Art

Various kinds of techniques for implementing automated driving of a vehicle have been proposed. International Publication No. 2019/116870 discloses that a first travel control means and a second travel control means, each capable of performing travel control of a vehicle, will be arranged, and in a case in which functional degradation is detected in one of these travel control means, alternative control will be performed by the other travel control means. By providing a redundant arrangement in which a plurality of travel control means are arranged in a vehicle in this manner, the reliability of the automated driving control of the vehicle is improved.

Different target control amounts may be determined for the vehicle by the first travel control means and the second travel control means due to differences in, for example, the processing performance and the input values of sensors, the control logic, or the like. In such a case, simply only switching the control performer which performs the travel control of a vehicle, between the first travel control means and the second travel control means will influence the stability of vehicle control and give a sense of incongruity to an occupant of the vehicle.

### SUMMARY OF THE INVENTION

The present invention improves, for example, the stability of vehicle control.

According to one aspect of the present invention, there is provided a vehicle control apparatus that controls automated driving of a vehicle, comprising: a first controller configured to perform travel control of the vehicle by controlling a first actuator; and a second controller configured to perform travel control of the vehicle by controlling a second actuator which is different from the first actuator, as alternative control to be performed in a case in which degradation of a control function is detected in the first controller, wherein in a case of starting the alternative control, the travel control of the vehicle by the first controller is gradually shifted to the travel control of the vehicle by the second controller.

Further features of the present invention will become apparent from the following description of exemplary embodiments with reference to the attached drawings.

### BRIEF DESCRIPTION OF THE DRAWINGS

FIG. 1 is a block diagram of a vehicle control apparatus according to an embodiment;

FIG. 2 is a block diagram of the vehicle control apparatus according to the embodiment;

FIG. 3 is a block diagram of the vehicle control apparatus according to the embodiment;

FIG. 4 is a block diagram of the vehicle control apparatus according to the embodiment;

FIG. 5 is a flowchart showing the control procedure of a first control unit and a second control unit according to Example 1:

FIG. 6 shows timing charts showing braking amounts a first actuator and a second actuator according to Example 1;

FIG. 7 is a flowchart showing the control procedure of the first control unit and the second control unit according to a modification of Example 1:

FIG. 8 is a flowchart showing the control procedure of the first control unit and the second control unit according to Example 2:

FIGS. 9A to 9C are timing charts showing steering amounts of the first actuator and the second actuator according to Example 2; and

FIG. 10 is a flowchart showing the control procedure of the first control unit and the second control unit according to a modification of Example 2.

### DESCRIPTION OF THE EMBODIMENTS

Hereinafter, embodiments will be described in detail with reference to the attached drawings. Note that the following embodiments are not intended to limit the scope of the claimed invention, and limitation is not made to an invention that requires all combinations of features described in the embodiments.

Two or more of the multiple features described in the embodiments may be combined as appropriate. Furthermore, the same reference numerals are given to the same or similar configurations, and redundant description thereof is omitted.

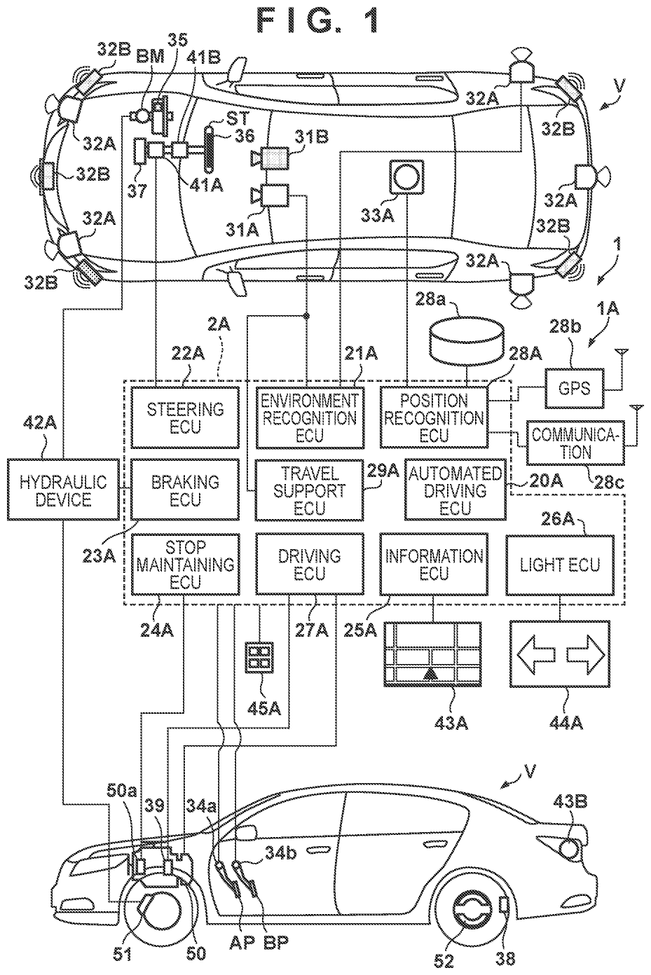

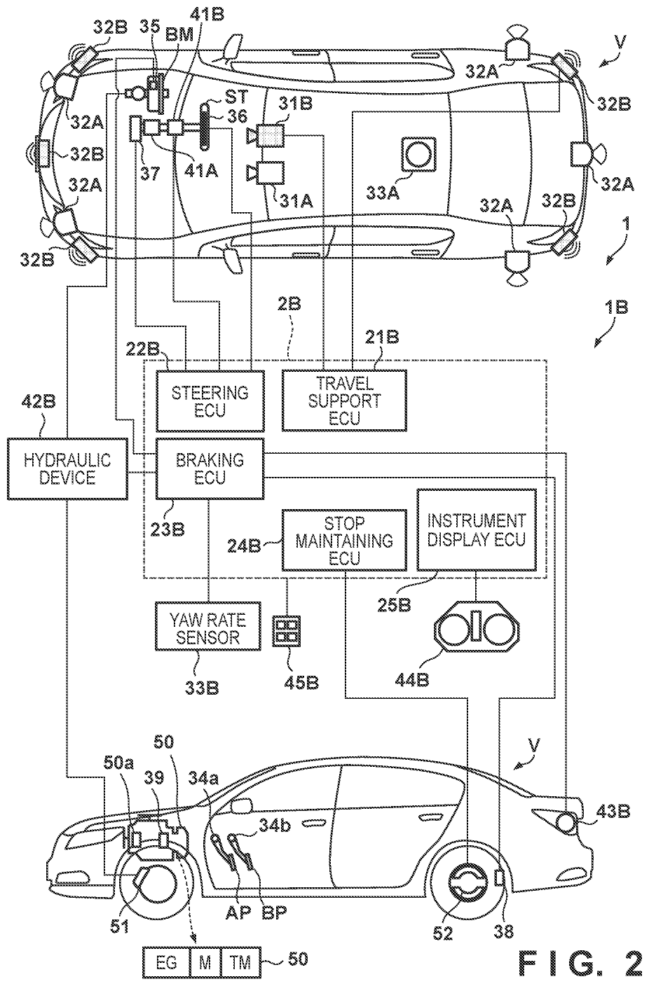

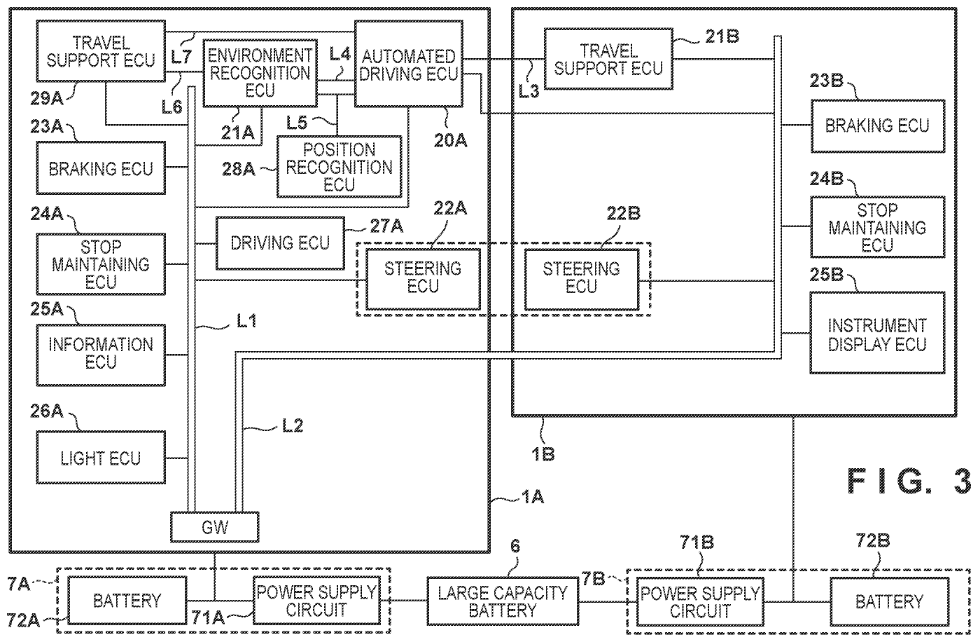

FIGS. 1 to 4 are block diagrams of a vehicle control apparatus 1 (control system) according to an embodiment of the present invention. The vehicle control apparatus 1 controls a vehicle V. In each of FIGS. 1 and 2, an outline of the vehicle V is shown in a plan view and a side view. As an example, the vehicle V is a sedan-type four-wheeled vehicle. The vehicle control apparatus 1 includes a first control unit 1A and a second control unit 1B. FIG. 1 is a block diagram showing the arrangement of the first control unit 1A, and FIG. 2 is a block diagram showing the arrangement of the second control unit 1B. FIG. 3 mainly shows the arrangement of communication lines between the first control unit 1A and the second control unit 1B and power supplies.

The first control unit 1A and the second control unit 1B make some functions implemented by the vehicle V multiplexed or redundant. This can improve the reliability of the vehicle control apparatus. The first control unit 1A performs, for example, not only automated driving control and normal operation control in manual driving but also travel support control concerning emergency avoidance and the like. The second control unit 1B mainly performs travel support control concerning emergency avoidance and the like. Travel support will be sometimes referred to as driving support. The first control unit 1A and the second control unit 1B are caused to perform different control processes while making the functions redundant, thereby improving the reliability while distributing the control processes.

The vehicle V according to this embodiment is a parallel hybrid vehicle. FIG. 2 schematically shows the arrangement of a power plant 50 that outputs a driving force to rotate the driving wheels of the vehicle V. The power plant 50 includes an internal combustion engine EG, a motor M, and an automatic transmission TM. The motor M is usable as a driving source to accelerate the vehicle V and is also usable as a power generator upon deceleration or the like (regenerative braking).

<First Control Unit 1A>

The arrangement of the first control unit 1A will be described with reference to FIG. 1. The first control unit 1A includes an ECU group (control unit group) 2A. The ECU group 2A includes a plurality of ECUs 20A to 29A. Each ECU includes a processor represented by a CPU, a storage device such as a semiconductor memory, an interface with an external device, and the like. The storage device stores programs to be executed by the processor, data to be used by the processor for processing, and the like. Each ECU may include a plurality of processors, storage devices, and interfaces. Note that the number of ECUs and the provided functions can appropriately be designed, and they can be subdivided or integrated as compared to this embodiment. Note that in FIGS. 1 and 3, the names of the representative functions of the ECUs 20A to 29A are given. For example, the ECU 20A is denoted by “automated driving ECU”.

The ECU 20A executes control associated with automated driving as travel control of the vehicle V. In automated driving, at least one of driving (acceleration of the vehicle V by the power plant 50, and the like), steering, and braking of the vehicle V is automatically performed independently of the driving operation of the driver. In this embodiment, driving, steering, and braking are automatically performed.

The ECU 21A is an environment recognition unit configured to recognize the travel environment of the vehicle V based on the detection results of detection units 31A and 32A that detect the peripheral situation of the vehicle V. The ECU 21A generates target data (to be described later) as peripheral environment information.

In this embodiment, the detection unit 31A is an image capturing device (to be sometimes referred to as the camera 31A hereinafter) configured to detect an object around the vehicle V by image capturing. The camera 31A is provided at the front portion of the roof of the vehicle V to capture the front side of the vehicle V. When images captured by the camera 31A are analyzed, the contour of a target or a division line (a white line or the like) of a lane on a road can be extracted.

In this embodiment, the detection unit 32A is a LiDAR (Light Detection and Ranging) (to be sometimes referred to as the LiDAR 32A hereinafter) configured to detect an object around the vehicle V by light, and detects a target around the vehicle V or measures the distance to a target. In this embodiment, five LiDARs 32A are provided; one at each corner of the front portion of the vehicle V, one at the center of the rear portion, and one on each side of the rear portion. The number of LiDARs 32A and their arrangement can appropriately be selected.

The ECU 29A is a travel support unit configured to execute control associated with travel support (in other words, driving support) as travel control of the vehicle V based on the detection result of the detection unit 31A.

The ECU 22A is a steering control unit configured to control an electric power steering device 41A. The electric power steering device 41A includes a mechanism that steers the front wheels in accordance with the driving operation (steering operation) of the driver on a steering wheel ST The electric power steering device 41A includes a motor that generates a driving force to assist the steering operation or automatically steer the front wheels, a sensor that detects the rotation amount of the motor, a torque sensor that detects the steering torque on the driver, and the like.

The ECU 23A is a braking control unit configured to control a hydraulic device 42A. The hydraulic device 42A implements, for example, an ESB (Electric Servo Brake). A braking operation of the driver on a brake pedal BP is converted into a fluid pressure by a brake master cylinder BM and transmitted to the hydraulic device 42A. The hydraulic device 42A is an actuator capable of controlling, based on the fluid pressure transmitted from the brake master cylinder BM, the fluid pressure of hydraulic oil to be supplied to a brake device (for example, a disc brake device) 51 provided in each of the four wheels. The ECU 23A performs driving control of a solenoid valve and the like provided in the hydraulic device 42A. In this embodiment, the ECU 23A and the hydraulic device 42A form an electric servo brake. The ECU 23A controls, for example, the distribution of a braking force by the four brake devices 51 and a braking force by regenerative braking of the motor M.

The ECU 24A is a stop maintaining control unit configured to control an electric parking lock device 50a provided in the automatic transmission TM. The electric parking lock device 50a includes a mechanism that locks the internal mechanism of the automatic transmission TM mainly when the P range (Park range) is selected. The ECU 24A can control lock and unlock by the electric parking lock device 50a.

The ECU 25A is an in-vehicle notification control unit configured to control an information output device 43A for performing information notification to occupants in the vehicle. The information output device 43A includes, for example, a display device such as a head-up display and a sound output device. The information output device 43A may further include a vibration device. The ECU 25A causes the information output device 43A to output, for example, various kinds of information such as a vehicle speed and an atmospheric temperature and information such as a path guidance.

The ECU 26A is an external notification control unit configured to control an information output device 44A that performs information notification to the outside of the vehicle. In this embodiment, the information output device 44A is a direction indicator (hazard lamp). The ECU 26A controls blinking of the information output device 44A serving as a direction indicator, thereby notifying the outside of the vehicle of the advancing direction of the vehicle V. In addition, the ECU 26A controls blinking of the information output device 44A serving as a hazard lamp to increase the attention of the outside to the vehicle V.

The ECU 27A is a driving control unit configured to control the power plant 50. In this embodiment, one ECU 27A is assigned to the power plant 50. However, one ECU may be assigned to each of the internal combustion engine EG, the motor M, and the automatic transmission TM. The ECU 27A controls the output of the internal combustion engine EG or the motor M or switches the gear range of the automatic transmission TM in correspondence with, for example, the driving operation of the driver detected by an operation detection sensor 34a provided on an accelerator pedal AP or an operation detection sensor 34b provided on the brake pedal BR the vehicle speed, or the like. Note that as a sensor that detects the travel state of the vehicle V, a rotation speed sensor 39 that detects the rotation speed of the output shaft of the automatic transmission TM is provided in the automatic transmission TM. The vehicle speed of the vehicle V can be calculated from the detection result of the rotation speed sensor 39.

The ECU 28A is a position recognition unit configured to recognize the current position or the route of the vehicle V. The ECU 28A performs control of a gyro sensor 33A, a GPS sensor 28b, and a communication device 28c and information processing of a detection result or a communication result. The gyro sensor 33A detects the rotary motion of the vehicle V. The route of the vehicle V can be determined based on the detection result of the gyro sensor 33A, and the like. The GPS sensor 28b detects the current position of the vehicle V The communication device 28c performs wireless communication with a server configured to provide map information and traffic information, and acquires these pieces of information. A database 28a can store accurate map information. The ECU 28A can more accurately specify the position of the vehicle V on a lane based on the map information and the like.

An input device 45A is arranged in the vehicle so as to be operable by the driver, and accepts input of an instruction or information from the driver.

<Second Control Unit 1B>

The arrangement of the second control unit 1B will be described with reference to FIG. 2. The second control unit 1B includes an ECU group (control unit group) 2B. The ECU group 2B includes a plurality of ECUs 21B to 25B. Each ECU includes a processor represented by a CPU, a storage device such as a semiconductor memory, an interface with an external device, and the like. The storage device stores programs to be executed by the processor, data to be used by the processor for processing, and the like. Each ECU may include a plurality of processors, storage devices, and interfaces. Note that the number of ECUs and the provided functions can appropriately be designed, and they can be subdivided or integrated as compared to this embodiment. Note that in FIGS. 2 and 3, the names of the representative functions of the ECUs 21B to 25B are given, like the ECU group 2A.

The ECU 21B is an environment recognition unit configured to recognize the travel environment of the vehicle V based on the detection results of detection units 31B and 32B that detect the peripheral situation of the vehicle V and also serves as a travel support unit configured to execute control associated with travel support (in other words, driving support) as travel control of the vehicle V. The ECU 21B generates target data (to be described later) as peripheral environment information.

Note that in this embodiment, the ECU 21B has the environment recognition function and the travel support function. However, an ECU may be provided for each function, like the ECU 21A and the ECU 29A of the first control unit 1A. Conversely, in the first control unit 1A, the functions of the ECU 21A and the ECU 29A may be implemented by one ECU, like the ECU 21B.

In this embodiment, the detection unit 31B is an image capturing device (to be sometimes referred to as the camera 31B hereinafter) configured to detect an object around the vehicle V by image capturing. The camera 31B is provided at the roof front portion in the vehicle V to capture the front side of the vehicle V. When images captured by the camera 31B are analyzed, the contour of a target or a division line (a white line or the like) of a lane on a road can be extracted. In this embodiment, the detection unit 32B is a millimeter wave radar (to be sometimes referred to as the radar 32B hereinafter) configured to detect an object around the vehicle V by a radio wave, and detects a target around the vehicle V or measures the distance to a target. In this embodiment, five radars 32B are provided; one at the center of the front portion of the vehicle V, one at each corner of the front portion, and one at each corner of the rear portion. The number of radars 32B and their arrangement can appropriately be selected.

The ECU 22B is a steering control unit configured to control the electric power steering device 41B. The electric power steering device 41B includes a mechanism that steers the front wheels in accordance with the driving operation (steering operation) of the driver on the steering wheel ST. The electric power steering device 41B includes a motor that generates a driving force to assist the steering operation or automatically steer the front wheels, a sensor that detects the rotation amount of the motor, a torque sensor that detects the steering torque on the driver, and the like. In addition, a steering angle sensor 37 is electrically connected to the ECU 22B via a communication line L2 (to be described later), and the electric power steering device 41B can be controlled based on the detection result of the steering angle sensor 37. The ECU 22B can obtain the detection result of a grip sensor 36 that detects whether the driver is gripping the steering wheel ST, and can monitor the steering wheel gripping state of the driver.

The ECU 23B is a braking control unit configured to control a hydraulic device 42B. The hydraulic device 42B implements, for example, VSA (Vehicle Stability Assist). A braking operation of the driver on the brake pedal BP is converted into a fluid pressure by the brake master cylinder BM and transmitted to the hydraulic device 42B. The hydraulic device 42B is an actuator capable of controlling, based on the fluid pressure transmitted from the brake master cylinder BM, the fluid pressure of hydraulic oil to be supplied to the brake device 51 of each wheel. The ECU 23B performs driving control of a solenoid valve and the like provided in the hydraulic device 42B.

In this embodiment, the wheel speed sensor 38 provided in each of the four wheels, a yaw rate sensor 33B, and a pressure sensor 35 configured to detect the pressure in the brake master cylinder BM are electrically connected to the ECU 23B and the hydraulic device 42B, and an ABS function, traction control, and the posture control function for the vehicle V are implemented based on the detection results of these sensors. For example, the ECU 23B adjusts the braking force of each wheel based on the detection result of the wheel speed sensor 38 provided in each of the four wheels, thereby suppressing the skid of each wheel. In addition, the ECU 23B adjusts the braking force of each wheel based on the rotation angular speed about the vertical axis of the vehicle V detected by the yaw rate sensor 33B, thereby suppressing an abrupt posture change of the vehicle V.

The ECU 23B also functions as an external alarm control unit configured to control an information output device 43B that alarms information outside the vehicle. In this embodiment, the information output device 43B is a brake lamp, and the ECU 23B can light the brake lamp at the time of braking or the like. This can increase the attention of a following vehicle to the vehicle V.

The ECU 24B is a stop maintaining control unit configured to control an electric parking brake device (for example, a drum brake) 52 provided in each rear wheel. The electric parking brake device 52 includes a mechanism that locks the rear wheel. The ECU 24B can perform control to lock and unlock the rear wheels by the electric parking brake devices 52.

The ECU 25B is an in-vehicle alarm control unit configured to control an information output device 44B that alarms information in the vehicle. In this embodiment, the information output device 44B includes a display device arranged on the instrument panel. The ECU 25B can cause the information output device 44B to output various kinds of information such as a vehicle speed and fuel consumption.

An input device 45B is arranged in the vehicle so as to be operable by the driver, and accepts input of an instruction or information from the driver.

<Communication Lines>

An example of communication lines of the vehicle control apparatus 1, which communicably connect the ECUs, will be described with reference to FIG. 3. The vehicle control apparatus 1 includes communication lines L to L7 of wired communication. The ECUs 20A to 27A and 29A of the first control unit 1A are connected to the communication line L1. Note that the ECU 28A may also be connected to the communication line L1.

The ECUs 21B to 25B of the second control unit 1B are connected to the communication line L2. The ECU 20A of the first control unit 1A is also connected to the communication line L2. The communication line L3 connects the ECU 20A of the first control unit 1A and the ECU 21B of the second control unit 1B. The communication line L4 connects the ECU 20A and the ECU 21A of the first control unit 1A. The communication line L5 connects the ECU 20A, the ECU 21A, and the ECU 28A of the first control unit 1A. The communication line L6 connects the ECU 29A and the ECU 21A of the first control unit 1A. The communication line L7 connects the ECU 29A and the ECU 20A of the first control unit 1A.

The protocols of the communication lines L1 to L7 may be identical or different, and may be changed in accordance with the communication environment such as a communication speed, a communication amount, and durability. For example, the communication lines L3 and L4 may be Ethernet® from the viewpoint of communication speed. For example, the communication lines L1, L2, and L5 to L7 may be CAN.

The first control unit 1A includes a gateway GW The gateway GW relays the communication line L1 and the communication line L2. For this reason, for example, the ECU 21B can output a control instruction to the ECU 27A via the communication line L2, the gateway GW, and the communication line L1.

<Power Supply>

The power supply of the vehicle control apparatus 1 will be described with reference to FIG. 3. The vehicle control apparatus 1 includes a large capacity battery 6, a power supply 7A, and a power supply 7B. The large capacity battery 6 is a battery used to drive the motor M and charged by the motor M.

The power supply 7A is a power supply that supplies power to the first control unit 1A, and includes a power supply circuit 71A and a battery 72A. The power supply circuit 71A is a circuit that supplies the power of the large capacity battery 6 to the first control unit 1A, and, for example, lowers the output voltage (for example, 190 V) of the large capacity battery 6 to a reference voltage (for example, 12 V). The battery 72A is a lead battery of, for example, 12 V. Since the battery 72A is provided, the power can be supplied to the first control unit 1A even in a case in which the power supply of the large capacity battery 6 or the power supply circuit 71A is shut down or lowers.

The power supply 7B is a power supply that supplies power to the second control unit B, and includes a power supply circuit 71B and a battery 72B. The power supply circuit 71B is a circuit that is similar to the power supply circuit 71A and supplies the power of the large capacity battery 6 to the second control unit 1B. The battery 72B is a battery similar to the battery 72A, and is a lead battery of, for example, 12 V. Since the battery 72B is provided, the power can be supplied to the second control unit 1B even in a case in which the power supply of the large capacity battery 6 or the power supply circuit 71B is shut down or lowers.

<Overall Arrangement>

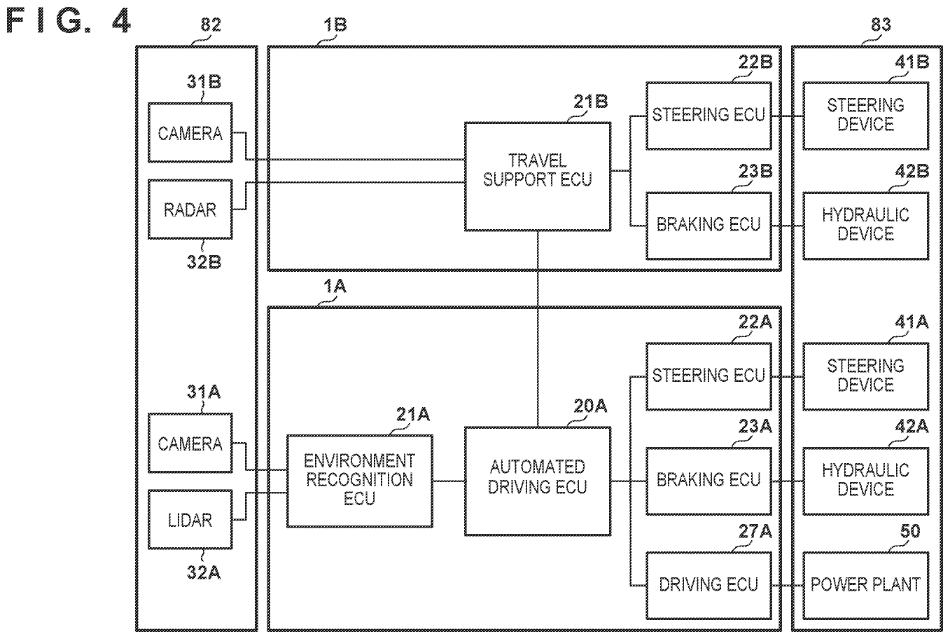

The overall arrangement of the vehicle V will be described from another viewpoint with reference to FIG. 4. The vehicle V includes the first control unit 1A, the second control unit 1B, an external recognition device group 82, and an actuator group 83. In FIG. 4, the ECU 20A, the ECU 21A, the ECU 22A, the ECU 23A, and the ECU 27A are exemplified as the ECUs which are included in the first control unit 1A, and the ECU 21B, the ECU 22B, and the ECU 23B are exemplified as the ECUs which are included in the second control unit 1B.

The external recognition device group 82 is a set of external recognition devices (sensors) mounted on the vehicle V The external recognition device group 82 includes the above-described cameras 31A and 31B, LiDAR 32A, and radar 32B. In this embodiment, the camera 31A and the LiDAR 32A are connected to the ECU 21A of the first control unit 1A, and operate in accordance with the instructions from the ECU 21A (that is, are controlled by the first control unit 1A). The ECU 21A acquires pieces of external information obtained by the camera 31A and the LiDAR 32A and supplies the pieces of external information to the ECU 20A of the first control unit 1A. Also, the camera 31B and the radar 32B are connected to the ECU 21B of the second control unit 1B, and operate in accordance with the instructions from the ECU 21B (that is, are controlled by the second control unit 1B). The ECU 21B acquires pieces of external information obtained by the camera 31B and the radar 32B, and supplies the pieces of external information to the ECU 20A of the first control unit 1A. This allows the first control unit 1A (the ECU 20A) to execute automated driving control using the pieces of external information obtained from each of the cameras 31A and 31B, the LiDAR 32A, and the radar 32B.

The actuator group 83 is a set of actuators mounted on the vehicle V The actuator group 83 includes, for example, the electric power steering device 41A, the electric power steering device 41B, the hydraulic device 42A, the hydraulic device 42B, and the power plant 50 described above. Each of the electric power steering device 41A and the electric power steering device 41B is a steering actuator for steering the vehicle V. Each of the first hydraulic device 42A and the second hydraulic device 42B is a braking actuator for performing braking of the vehicle V. In addition, the power plant 50 is a driving actuator for driving the vehicle V.

In this embodiment, the electric power steering device 41A, the first hydraulic device 42A, and the power plant 50 are connected to the ECU 20A via the ECU 22A, the ECU 23A, and the ECU 27A, respectively, and operate in accordance with the instructions from the ECU 20A (that is, are controlled by the first control unit 1A). In addition, the electric power steering device 41B and the second hydraulic device 42B are connected to the ECU 21B via the ECU 22B and the ECU 23B, respectively, and operate in accordance with the instructions from the ECU 21B (that is, are controlled by the second control unit 1B).

The first control unit 1A (the ECU 20A) communicates with some of the devices (the camera 31A and the LiDAR 32A) of the external recognition device group 82 via a communication path, and communicates with some of the devices (for example, the electric power steering device 41A, the hydraulic device 42A, and the power plant 50) of the actuator group 83 via another communication path. Also, the second control unit 1B (the ECU 21B) communicates with some of the devices (the camera 31B and the radar 32B) of the external recognition device group 82 via a communication path, and communicates with some of the devices (for example, the electric power steering device 41B and the hydraulic device 42B) of the actuator group 83 via another communication path. The communication path connected to the ECU 20A and the communication path connected to the ECU 21B may be different from each other. These communication paths may be, for example, CAN (Controller Area Network) or Ethernet®. The ECU 20A and the ECU 21B are connected to each other via a communication path. This communication path may be, for example, CAN (Controller Area Network) or Ethernet®. Alternatively, the ECUs may be connected by both CAN and Ethemet®.

The first control unit 1A (the ECU 20A) is formed by a processor such as a CPU or the like and a memory such as a RAM or the like, and is formed to be able to execute travel control (for example, automated driving control) of the vehicle V. For example, the ECU 20A acquires, as the pieces of external information obtained by the external recognition device group 82, the pieces of external information obtained by the camera 31A and the LiDAR 32A via the ECU 21A and the pieces of external information obtained by the camera 31B and the radar 32B via the ECU 21B. The ECU 20A generates, based on the acquired pieces of external information, a path to be taken by vehicle V and a speed at which the vehicle V is to travel during an automated driving operation, and determines target control amounts (a driving amount, a braking amount, and a steering amount) of the vehicle V for implementing this path and this speed. The ECU 20A generates, based on the determined target control amounts of the vehicle V, operation amounts (instruction values (signal values) of voltages, currents, or the like) of the respective actuators, and controls the actuator group 83 (the electric power steering device 41A, the first hydraulic device 42A, and the power plant 50) based on the operation amounts to perform travel control (for example, automated driving) of the vehicle V.

The ECU 20A can operate here as a detection unit, of the first control unit 1A, which detects the degradation of the travel control function of the vehicle V. For example, the ECU 20A can detect the degradation of the travel control function by monitoring the communication state of the communication path to the external recognition device group 82 and the communication state of the communication path to the actuator group 83 and detecting the degradation of the communication function with the external recognition device group 82 and the actuator group 83 based on these communication states. The degradation of the communication function can include the disconnection of communication, a reduction in the communication speed, and the like. The ECU 20A may also detect the degradation of the travel control function by detecting the degradation of the external detection performance of the external recognition device group 82 and the degradation of the driving performance of the actuator group 83. Furthermore, if the ECU 20A has been formed to diagnose its own processing performance (for example, the processing speed or the like), the ECU 20A may detect the degradation of the travel control function based on the result of this diagnosis. Note that although the ECU 20A operates as a detection unit that can detect its own travel function degradation in this embodiment, the present invention is not limited to this. The detection unit may be provided separately from the ECU 20A or the second control unit 1B (for example, the ECU 21B) may operate as the detection unit.

The second control unit 1B (the ECU 21B) is formed by a processor such as a CPU or the like and a memory such as a RAM or the like, and is formed to be able to execute travel control of the vehicle V. In a similar manner to the ECU 20A of the first control unit 1A, the ECU 21B can determine the target control amounts (the braking amount and the steering amount) of the vehicle V, generate the operation amounts of the respective actuators based on the determined target control amounts, and control the actuator group 83 (the electric power steering device 41B and the second hydraulic device 42B) based on the operation amounts. The ECU 21B will acquire the pieces of external information obtained by the camera 31B and the radar 32B and supplies the pieces of external information to the ECU 20A during a normal state in which the degradation of the travel control function is not detected in the ECU 20A. However, the ECU 21B will perform travel control (that is, perform alternative control) of the vehicle V instead of the ECU 20A if the degradation of the travel control function is detected in the ECU 20A. Alternative control can include, for example, degeneracy (fallback) control in which in accordance with the automated driving control level of the vehicle V, a function restriction of degrading the control level is executed.

### Control Example

As described above, in the vehicle control apparatus 1 according to this embodiment, in a case in which the degradation of the travel control function is detected in the first control unit 1A that is executing the automated driving control, the second control unit 1B will perform travel control (alternative control) of the vehicle V instead of the first control unit 1A. By providing a redundant arrangement that includes a plurality of control units, the reliability of automated driving control of the vehicle can be improved. On the other hand, different target control amounts may be determined for the vehicle by the first travel control unit 1A and the second travel control unit 1B due to differences in, for example, the processing performance and the input values of sensors, the control logic, or the like. In this case, if the control performer (the main subject of control) that is to execute the travel control of the vehicle V is simply switched from the first control unit 1A to the second control unit 1B, the behavior (for example, the vertical g-force, the horizontal g-force, and the vibration) of the vehicle V will change greatly at the time of switching. This will influence the stability of vehicle control and give a sense of incongruity to the occupant of the vehicle V. Note that the difference between the control for traveling in an “out-in-out” manner to prioritize the comfort of the ride and the control for traveling in the middle of a road to prioritize safety can be raised as the difference in the control logic in, for example, the example of steering control performed when the vehicle is traveling a curve.

Hence, in the vehicle control apparatus 1 according to this embodiment, at the start of alternative control by the second control unit 1B, the travel control of the vehicle V performed by the first control unit 1A is gradually shifted to the travel control of the vehicle V performed by the second control unit 1B. In this case, the first control unit 1A performs the travel control of the vehicle V by controlling a first actuator, and the second control unit 1B performs the travel control of the vehicle V by controlling a second actuator which is different from the first actuator. The first actuator and the second actuator can be defined as devices that are used under the same control item in the travel control of the vehicle V. For example, in a case in which the braking of the vehicle V is to be controlled as the control item, the first actuator and the second actuator will correspond to the hydraulic device 42A and the hydraulic device 42B, respectively. Also, in a case in which the steering of the vehicle V is to be controlled as the control item, the first actuator and the second actuator will correspond to the electric power steering device 41A and the electric power steering device 41B, respectively.

### Example 1

Example 1 will describe an example of controlling the braking of a vehicle V. In this example, the control amount of the vehicle V refers to the “braking amount”, and the first actuator and the second actuator correspond to the “hydraulic device 42A” and the “hydraulic device 42B”, respectively.

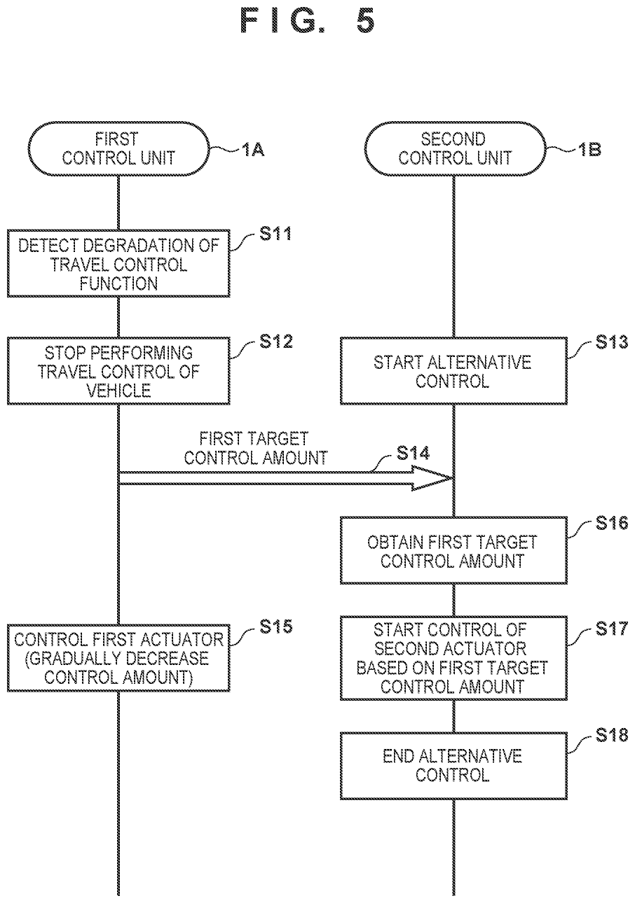

FIG. 5 is a flowchart showing the control procedure of the first control unit 1A and the second control unit 1B. In a case in which the degradation of the travel control function of the first control unit 1A is detected (step S11), the first control unit 1A will stop performing the travel control of the vehicle V (step S12) and transfer the control performer of the travel control of the vehicle V to the second control unit 1B. This will allow the second control unit 1B to start the alternative control (step S13). The first control unit 1A will also transmit, to the second control unit 1B, the target control amount (first target control amount) of the vehicle V which is determined before the start (more preferably, immediately before the start) of the alternative control (step S14), and control the first actuator so that the control amount of the vehicle V by the first actuator will gradually decrease (step S15). The second control unit 1B will inherit the first target control amount from the first control unit 1A (step S16) and start the control of the second actuator based on the inherited first target control amount (step S17). Subsequently, the alternative control ends (step S18) when the vehicle V has stopped, has been switched to manual driving, or the like.

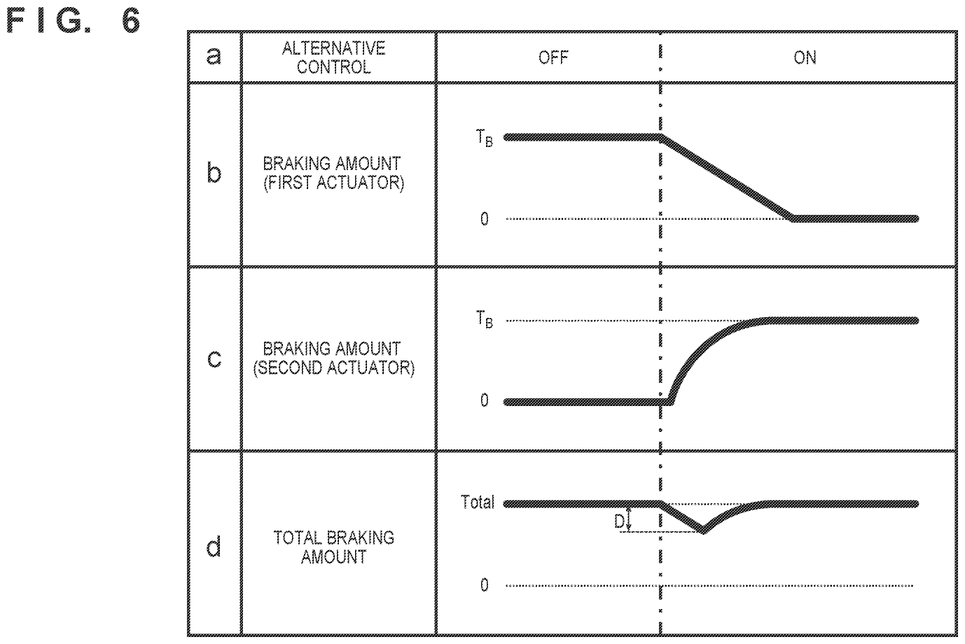

FIG. 6 shows timing charts showing the braking amounts of the first actuator (the hydraulic device 42A) and the second actuator (the hydraulic device 42B). In FIG. 6, (a) shows the start timing of alternative control by the second control unit 1B. In FIG. 6, (b) shows the timing chart of the braking amount generated by the first actuator (the hydraulic device 42A) by the control of the first control unit 1A, and in FIG. 6, (c) shows the timing chart of the braking amount generated by the second actuator (the hydraulic device 42B) by the control of the second control unit 1B. In addition, in FIG. 6, (d) shows the total of the braking amount of the first actuator and the braking amount of the second actuator.

As shown in (b) of FIG. 6, before the start of alternative control by the second control unit 1B, the first control unit 1A determines the target control amount (a first target braking amount TB) of the vehicle V and controls the first actuator (the hydraulic device 42A) based on the determined first target braking amount TB. On the other hand, if the degradation of the travel control function of the first control unit 1A is detected, the second control unit 1B will inherit the first target braking amount TB from the first control unit 1A and start performing the alternative control by controlling the second actuator so that the first target braking amount TB will be generated. In this case, as shown in (c) of FIG. 6, there may be a delay in the response of the hydraulic device 42B, as the second actuator of this example, to the start of the alternative control by the second control unit 1B. Hence, as shown in (b) of FIG. 6, the first control unit 1A will control the first actuator so that the braking amount of the first actuator will gradually decrease. As a result, a change amount D of the total value of the braking amount of the first actuator and the braking amount of the second actuator can be reduced as shown in (d) of FIG. 6, thus improving the stability of the vehicle control and reducing the sense of incongruity given to the occupant of the vehicle V.

It is preferable for the first control unit 1A to gradually reduce the braking amount of the first actuator so a reduction rate of the braking amount of the first actuator after the start of the alternative control will not exceed a predetermined limit value. The reduction rate of the braking amount refers to the braking amount to be reduced per unit time. The limit value is, for example, the permitted upper limit value of the reduction rate of the braking amount, and can be set in advance based on an experiment or the like so that the sense of incongruity given to the occupant will fall within a tolerable range.

### Modification of Example 1

The above Example 1 described an example in which the second control unit 1B inherits the first target control amount (the first target braking amount TB) determined by the first control unit 1A before the start (immediately before the start) of the alternative control, and controls the second actuator based on the first target control amount. However, the present invention is not limited to this, and the second control unit 1B may acquire the control amount (braking amount) of the vehicle V that was actually generated by the first actuator before the start (for example, immediately before the start) of the alternative control, and control the second actuator based on this acquired control amount.

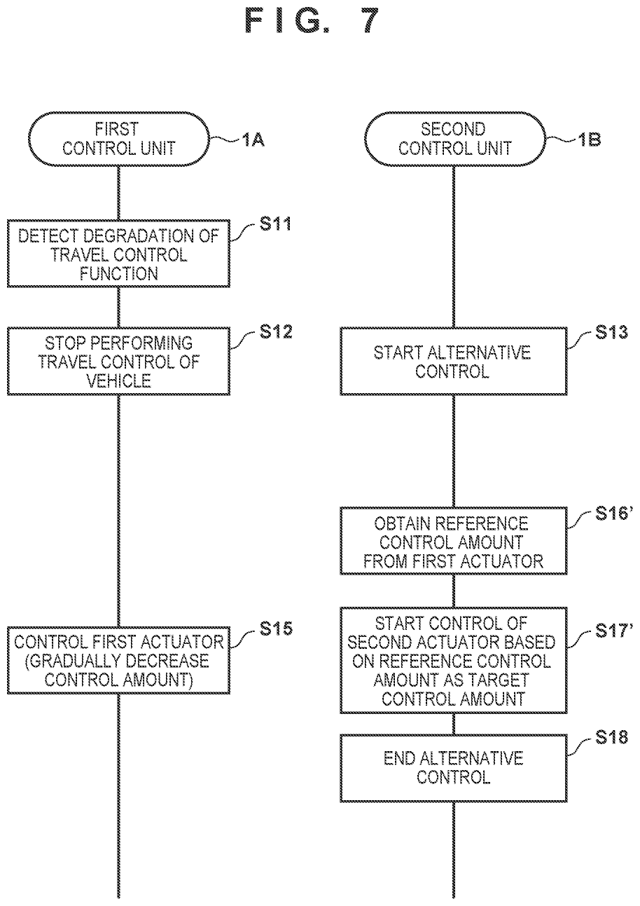

FIG. 7 is a flowchart showing the control procedure of the first control unit 1A and the second control unit 1B. In contrast to the control procedure shown in FIG. 5, the process of step S14 has been deleted and the processes of steps S16 and S17 have been replaced with the processes of steps S16′ and S17′ in the control procedure shown in FIG. 7. In addition, other processes (steps S11 to S13, S15, and S18) are similar to those of the control procedure shown in FIG. 5 and are as described above.

In step S16′, the second control unit 1B acquires, from the first actuator, the control amount (braking amount) of the vehicle V, which was actually generated by the first actuator before the start (preferably, immediately before the start) of the alternative control, as a reference control amount (reference braking amount). Subsequently, in step S17′, the second control unit 1B sets the reference control amount acquires in step S16′ as the target control amount (target braking amount), and controls the second actuator based on the set target control amount. The timing charts of the braking amounts of the first actuator (the hydraulic device 42A) and the second actuator (the hydraulic device 42B) of this modification here are similar to those exemplified in FIG. 6. However, the target braking amount of the second actuator shown in (c) of FIG. 6 is replaced by a reference braking amount TB′ from the first target braking amount TB. That is, in this modification, the second control unit 1B starts executing the alternative control by controlling the second actuator so that the reference braking amount TB′ set as the target braking amount will be generated.

### Example 2

Example 2 will describe an example of controlling the steering of the vehicle V. In this example, the control amount of the vehicle V refers to the “steering amount”, and the first actuator and the second actuator correspond to the “electric power steering device 41A” and the “electric power steering device 41B”, respectively.

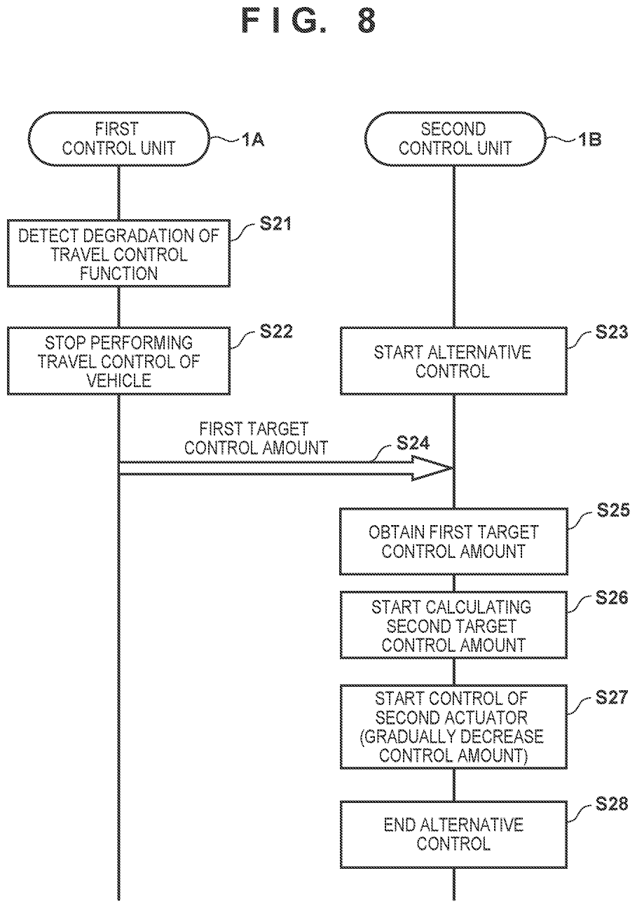

FIG. 8 is a flowchart showing the control procedure of the first control unit 1A and the second control unit 1B. Ina case in which the degradation of the travel control function of the first control unit 1A is detected (step S21), the first control unit 1A will stop performing the travel control of the vehicle V (step S22) and transfer the control performer of the travel control of the vehicle V to the second control unit 1B. This will allow the second control unit 1B to start the alternative control (step S23). The first control unit 1A will also transmit, to the second control unit 1B, the target control amount (first target control amount) of the vehicle V which is determined before the start (more preferably, immediately before the start) of the alternative control (step S24). The second control unit 1B will inherit the first target control amount from the first control unit 1A (step S25), and start calculating the target control amount (the second target control amount) of the vehicle V (step S26). The calculation of the second target control amount can be performed based on the pieces of external information obtained by some of the sensors (for example, the camera 31B and the radar 32B) of the external recognition device group 82. In addition, after the alternative control has started, the second control unit 1B will start the control of the second actuator so that the target control amount of the vehicle V will gradually change from the first target control amount to the second target control amount (step S27). Subsequently, the alternative control ends (step S28) when the vehicle V has stopped, has been switched to manual driving, or the like.

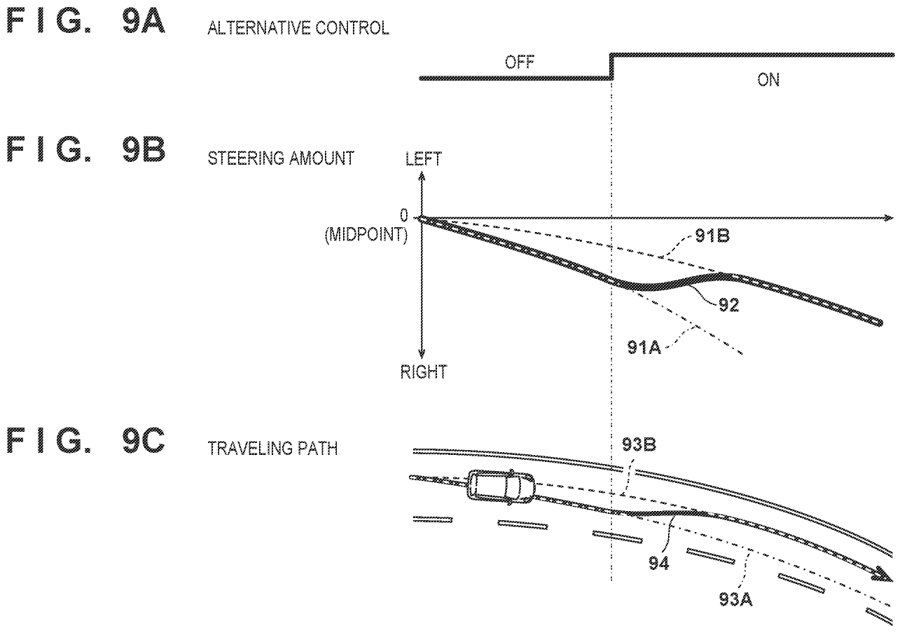

FIGS. 9A to 9C are timing charts showing the steering amounts of the first actuator (the electric power steering device 41A) and the second actuator (the electric power steering device 41B). FIG. 9A shows the start timing of the alternative control by the second control unit 1B. FIG. 9B shows the target steering amount of the vehicle V, and FIG. 9C shows a travel path of the vehicle V when the vehicle V is controlled by the target steering amount shown in FIG. 9B. Note that FIG. 9B shows a target steering amount (a first target steering amount 91A) of the vehicle V determined by the first control unit 1A, a target steering amount (a second target steering amount 91B) of the vehicle V determined by the second control unit 1B, and a target steering amount 92 to be used for steering control of the vehicle V. In addition, FIG. 9C shows a travel path 93A of the vehicle V in a case in which the steering control of the vehicle V is performed based on the first target steering amount 91A, a travel path 93B of the vehicle V in a case in which the steering control of the vehicle V is performed based on the second target steering amount 91B, and a travel path 94 of the vehicle V in a case in which the steering control of the vehicle V is performed based on the target steering amount 92.

As shown in FIG. 9B, before the start of alternative control by the second control unit 1B, the first control unit 1A determines the target steering amount (the first target steering amount 91A) of the vehicle V and controls the first actuator (the electric power steering device 41A) based on the first target steering amount 91A. On the other hand, if the degradation the travel control function of the first control unit 1A is detected, the second control unit 1B will inherit the first target steering amount 91A from the first control unit 1A and start to calculate the target steering amount (the second target steering amount 91B) of the vehicle V based on the pieces of external information obtained from some of the sensors (for example, the camera 31B and the radar 32B) of the external recognition device group 82.

At this time, if the target steering amount to be used in the steering control of the vehicle V is immediately changed from the first target steering amount 91A to the second target steering amount 91B, the horizontal g-force on the vehicle V will increase instantly, thus giving a sense of incongruity to the occupant. Hence, the second control unit 1B of this example will gradually change the target steering amount 92 to be used for the steering control of the vehicle V from the first target steering amount 91A to the second target steering amount 91B as shown in FIG. 9B. Since this will allow the second control unit 1B to control the second actuator (the electric power steering device 41B) so that the steering amount of the vehicle V will gradually change from the first target steering amount 91A to the second target steering amount 91B, the stability of the vehicle control can be improved, and the sense of incongruity given to the occupant of the vehicle V can be decreased.

It is preferable for the first control unit 1A to gradually change the steering amount of the second actuator so a change rate of the target steering amount of the vehicle V (alternatively, a change rate of the steering amount of the vehicle V) will not exceed a predetermined limit value. The change rate of the steering amount refers to the steering amount to be changed per unit time. The limit value is, for example, the permitted upper limit value of the change rate of the steering amount, and can be set in advance based on an experiment or the like so that the sense of incongruity given to the occupant will fall within a tolerable range.

### Modification of Example 2

The above Example 2 described an example in which the first target control amount (the first target steering amount 91A) determined by the first control unit 1A is inherited before the start (immediately before the start) of the alternative control, and the second actuator is controlled based on the first target control amount. However, the present invention is not limited to this, and the second control unit 1B may acquire the control amount (steering amount) of the vehicle V that was actually generated by the first actuator before the start (for example, immediately before the start) of the alternative control, and control the second actuator based on this acquired control amount.

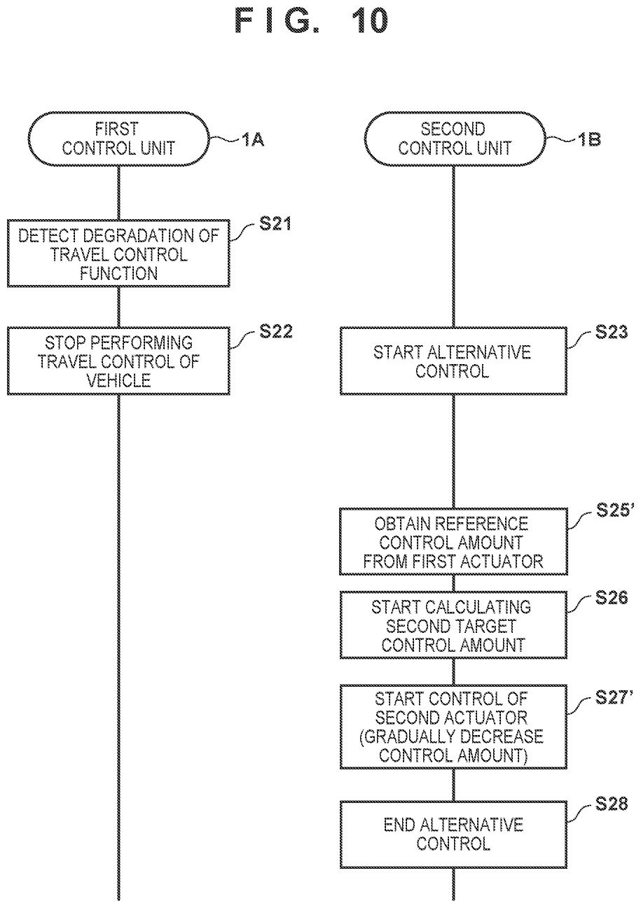

FIG. 10 is a flowchart showing the control procedure of the first control unit 1A and the second control unit 1B. In contrast to the control procedure shown in FIG. 8, the process of step S24 has been deleted and the processes of steps S25 and S27 have been replaced with the processes of steps S25′ and S27′ in the control procedure shown in FIG. 10. In addition, other processes (steps S21 to S23. S26, and S28) are similar to those of the control procedure shown in FIG. 8 and are as described above.

In step S25′, the second control unit 1B acquires, from the first actuator, the control amount (steering amount) of the vehicle V, which was actually generated by the first actuator before the start (preferably, immediately before the start) of the alternative control, as a reference control amount (reference steering amount). Subsequently, in step S26, the second control unit 1B starts calculating the second target control amount (the second target steering amount) as the target control amount of the vehicle V In addition, in step S27′, the second control unit 1B starts controlling the second actuator so that the target control amount of the vehicle V will gradually change from the reference control amount acquired in step S25′ to the second target control amount.

### Summary of Embodiment

1. A vehicle control apparatus of the above-described embodiment is a vehicle control apparatus (for example, 1) that controls automated driving of a vehicle (for example, V), comprising:

a first controller (for example, 1A) configured to perform travel control of the vehicle by controlling a first actuator (for example, 41A, 42A); and

a second controller (for example, 1B) configured to perform travel control of the vehicle by controlling a second actuator (for example, 41B, 42B) which is different from the first actuator, as alternative control to be performed in a case in which degradation of a control function is detected in the first controller,

wherein in a case of starting the alternative control, the travel control of the vehicle by the first controller is gradually shifted to the travel control of the vehicle by the second controller.

According to this embodiment, since the influence on the vehicle from switching the control performer which performs the travel control of the vehicle will be decreased, the stability of vehicle control can be improved, and the sense of incongruity felt by the occupant can be reduced.

2. In the above-described embodiment, the first actuator and the second actuator are used under the same control item in the travel control of the vehicle.

According to this embodiment, since it is possible to reduce the influence on the vehicle from switching the control performer under the same control item at the start of the alternative control, the stability of vehicle control can be improved, and the sense of incongruity felt by the occupant can be reduced.

3. In the above-described embodiment, in a case of starting the alternative control, the first controller is configured to control the first actuator so that a control amount of the vehicle by the first actuator will gradually decrease.

According to this embodiment, since the control of the first actuator by the first controller can be shifted smoothly to the control of the second actuator by the second controller, the stability of vehicle control can be further improved, and the sense of incongruity felt by the occupant can be further reduced.

4. In the above-described embodiment, in a case of starting the alternative control, the first controller is configured to control the first actuator so that a reduction rate of the control amount of the vehicle by the first actuator will not exceed a predetermined limit value.

According to this embodiment, the control of the first actuator by the first controller can be shifted even more smoothly to the control of the second actuator by the second controller.

5. In the above-described embodiment, each of the first actuator and the second actuator is an actuator (for example, 42A, 42B) configured to perform braking of the vehicle.

According to this embodiment, when the alternative control is to be started for the braking of the vehicle, the stability of vehicle control can be improved, and the sense of incongruity felt by the occupant can be reduced.

6. In the above-described embodiment, in a case of starting the alternative control, the second controller is configured to acquire a first target control amount of the vehicle determined by the first controller before starting the alternative control, and control the second actuator based on the first target control amount.

According to this embodiment, since the alternative control is started based on a target control amount that was used before the start of the alternative control, the stability of vehicle control can be improved, and the sense of incongruity felt by the occupant can be reduced.

7. In the above-described embodiment, in a case of starting the alternative control, the second controller is configured to determine a second target control amount of the vehicle based on external information obtained by a sensor (for example, 82) of the vehicle, and control the second actuator so that a control amount of the vehicle will gradually change from the first target control amount to the second target control amount.

According to this embodiment, since the control of the first actuator by the first controller can be shifted smoothly to the control of the second actuator by the second controller, the stability of vehicle control can be further improved, and the sense of incongruity felt by the occupant can be further reduced.

8. In the above-described embodiment, in a case of starting the alternative control, the second controller is configured to acquire, as a reference control amount, a control amount of the vehicle which was generated by the first actuator before starting the alternative control, and control the second actuator based on the reference control amount.

According to this embodiment, since the alternative control is started based on a control amount of the vehicle that was generated by the first actuator before the start of the alternative control, the stability of vehicle control can be improved, and the sense of incongruity felt by the occupant can be reduced.

9. In the above-described embodiment, in a case of starting the alternative control, the second controller is configured to determine a second target control amount of the vehicle based on external information obtained by a sensor (for example, 82) of the vehicle, and control the second actuator so that the control amount of the vehicle will gradually change from the reference control amount to the second target control amount.

According to this embodiment, since the control of the first actuator by the first controller can be shifted smoothly to the control of the second actuator by the second controller, the stability of vehicle control can be further improved, and the sense of incongruity felt by the occupant can be further reduced.

10. In the above-described embodiment, in a case of starting the alternative control, the second controller is configured to control the second actuator so that a change rate of the control amount of the vehicle will not exceed a predetermined limit value.

According to this embodiment, the control of the first actuator by the first controller can be shifted even more smoothly to the control of the second actuator by the second controller.

11. In the above-described embodiment, each of the first actuator and the second actuator is an actuator (for example, 41A, 41B) configured to perform steering of the vehicle.

According to this embodiment, when the alternative control is to be started for steering of the vehicle, the stability of vehicle control can be improved, and the sense of incongruity felt by the occupant can be reduced.

The invention is not limited to the foregoing embodiments, and various variations/changes are possible within the spirit of the invention.

What is claimed is:

1. A vehicle control apparatus that controls automated driving of a vehicle, comprising:
a first controller configured to perform travel control of the vehicle by controlling a first actuator; and
a second controller configured to perform travel control of the vehicle by controlling a second actuator which is different from the first actuator, as alternative control to be performed in a case in which degradation of a control function is detected in the first controller,
wherein in a case of starting the alternative control, the travel control of the vehicle by the first controller is gradually shifted to the travel control of the vehicle by the second controller.

2. The vehicle control apparatus according to claim 1, wherein the first actuator and the second actuator are used under the same control item in the travel control of the vehicle.

3. The vehicle control apparatus according to claim 1, wherein in a case of starting the alternative control, the first controller is configured to control the first actuator so that a control amount of the vehicle by the first actuator will gradually decrease.

4. The vehicle control apparatus according to claim 3, wherein in a case of starting the alternative control, the first controller is configured to control the first actuator so that a reduction rate of the control amount of the vehicle by the first actuator will not exceed a predetermined limit value.

5. The vehicle control apparatus according to claim 3, wherein each of the first actuator and the second actuator is an actuator configured to perform braking of the vehicle.

6. The vehicle control apparatus according to claim 1, wherein in a case of starting the alternative control, the second controller is configured to acquire a first target control amount of the vehicle determined by the first controller before starting the alternative control, and control the second actuator based on the first target control amount.

7. The vehicle control apparatus according to claim 6, wherein in a case of starting the alternative control, the second controller is configured to determine a second target control amount of the vehicle based on external information obtained by a sensor of the vehicle, and control the second actuator so that a control amount of the vehicle will gradually change from the first target control amount to the second target control amount.

8. The vehicle control apparatus according to claim 7, wherein in a case of starting the alternative control, the second controller is configured to control the second actuator so that a change rate of the control amount of the vehicle will not exceed a predetermined limit value.

9. The vehicle control apparatus according to claim 6, wherein each of the first actuator and the second actuator is an actuator configured to perform steering of the vehicle.

10. The vehicle control apparatus according to claim 1, wherein in a case of starting the alternative control, the second controller is configured to acquire, as a reference control amount, a control amount of the vehicle which was generated by the first actuator before starting the alternative control, and control the second actuator based on the reference control amount.

11. The vehicle control apparatus according to claim 10, wherein in a case of starting the alternative control, the second controller is configured to determine a second target control amount of the vehicle based on external information obtained by a sensor of the vehicle, and control the second actuator so that the control amount of the vehicle will gradually change from the reference control amount to the second target control amount.

12. The vehicle control apparatus according to claim 11, wherein in a case of starting the alternative control, the second controller is configured to control the second actuator so that a change rate of the control amount of the vehicle will not exceed a predetermined limit value.

13. The vehicle control apparatus according to claim 10, wherein each of the first actuator and the second actuator is an actuator configured to perform steering of the vehicle.

14. A vehicle comprising:
a vehicle control apparatus defined in claim 1; and
a first actuator and a second actuator.

15. A vehicle control method for controlling automated driving of a vehicle that comprises
a first controller configured to perform travel control of the vehicle by controlling a first actuator, and
a second controller configured to perform travel control of the vehicle by controlling a second actuator which is different from the first actuator, as alternative control to be performed in a case in which degradation of a control function is detected in the first controller,
wherein in a case of starting the alternative control, the travel control of the vehicle by the first controller is gradually shifted to the travel control of the vehicle by the second controller.
